(19) United States
(12) Patent Application Publication
(10) Pub. No.: US 2026/0354369 A1
(43) Pub. Date: Nov. 12, 2026

(54) Device for Dispensing Bait

(71) Applicant: Adrian Mallia, Attard (MT)

(72) Inventor: Adrian Mallia, Attard (MT)

(21) Appl. No.: 19/666,564

(22) Filed: May 4, 2026

(30) Foreign Application Priority Data
May 6, 2025 (DE) 20 2025 102 494.2

(51) Int. Cl. A01M 25/00

(52) U.S. Cl. CPC A01M 25/004

(57) ABSTRACT

“A device dispenses bait. The bait comprises toxic material for killing a pest. The device is placed in the area of a street furniture. The device comprises a container for receiving the bait. The device has an adapter linking the container to the street furniture.

### “RELATED APPLICATION DATA

This application claims priority benefit to German Utility Model patent application serial no. DE 20 2025 104 494.2, filed May 6, 2025, the disclosure of which is incorporated by reference herein.”

### DESCRIPTION

The invention refers to a device for dispensing bait, comprising toxic material for killing pest in the area of a street furniture.

### STATE OF THE ART

Known bait dispensers are easily recognisable as dispensers of poison bait. The appearance of such bait dispensers for releasing bait to remove pest and/or vermin acts as a deterrent to visitors to gardens or parks.

### OBJECT OF THE INVENTION

The object of the invention is to provide a device for receiving and dispensing toxic material.

A further object of the invention is to integrate the device into the shape of a street furniture.

### Solution

A device for dispensing bait, comprising toxic material for killing pest in the area of a street furniture.

The device comprises a container for receiving the bait.

The device has an adapter linking the container to the street furniture.

### Device and Container

The device can be designed in various shapes and forms.

The device comprises at least one container for receiving the bait (toxic material).

The container has at least two openings.

At least two openings differ in size and/or in diameter. The openings differ in size and/or diameter so that pests of different sizes can reach a corresponding bait. The opening with a smaller diameter prevents a larger animal from entering through the smaller opening and reaching an inappropriate bait.

The container comes with an opening just big enough to allow the targeted pest to enter the container and reach the material whilst protecting bigger animals from reaching it.

Because the device comprising at least one container is integrated into a street furniture, the device cannot be identified as a dispenser of toxic material (bait).

### Pest

A pest is any organism.

The pest can be found both inside and outside the home.

In general, the term pest is used to describe organisms that damage food and/or crops and/or livestock and/or forestry.

Examples of pests can include rats, mice, slugs, snails, ants and cockroaches. Of course, other animals can also be called pest.

### Bait

The bait comprises toxic material.

The toxic material is dispensed to kill any kind of pest. It goes without saying that other living pests and vermin could be controlled as well.

The bait may contain both a food attractant for the target pest and an appropriate poison.

### Street Furniture

A street furniture represent objects and pieces of equipment installed in a garden environment and/or along streets and roads.

The street furniture can serve various purposes. For example, the street furniture can be a bench and/or a flowerpot. Street furniture can also be a lamp or a litter bin. Of course, street furniture can also be other equipment.

Obviously, the street furniture can be arranged in a private garden and/or in a public area.

### EMBODIMENTS OF THE INVENTION

The container and/or the adapter is adapted to the street furniture.

The container comprises at least one opening for receiving pest.

The container comprises at least one opening for receiving a holder for bait.

The holder carrying bait is moveable relative to the container of the device.

The holder has features and/or a honeycomb structure for carrying the bait.

The container has a reinforcing structure for carrying the weight of the street furniture.

The container has at least one drain hole and/or drain channel to direct any leaking fluids away from the bait.

### Advantages of the Invention

To avoid the obvious look and/or feel of a toxic dispenser, the device holding the container for bait is integrated into the design geometry of the street furniture.

The device allows the poison dispenser to be placed in public and visible locations without having the appearance and perception of traditional poison dispensers.

### DRAWINGS

Further examples and advantageous embodiments of the invention are described in more detail below with reference to the figures. The drawings show:

FIG. 1 a part of a street furniture that has an adapter for connection to a bait holder,

FIG. 2 a perspective view of a part of the street furniture,

FIG. 3 a perspective view of an adapter,

FIG. 4 a perspective view of the container,

FIG. 5 a perspective view of a bait holder of the device carrying the bait,

FIG. 6 a bait holder comprising a re-setting clip,

FIG. 7 a top view of the container of the device,

FIG. 8 a side view of the container of the device, and

FIG. 9 from the top view, an insight into the interior of the device.

FIG. 10 shows a top view of the container of the device.

### DETAILED DESCRIPTION

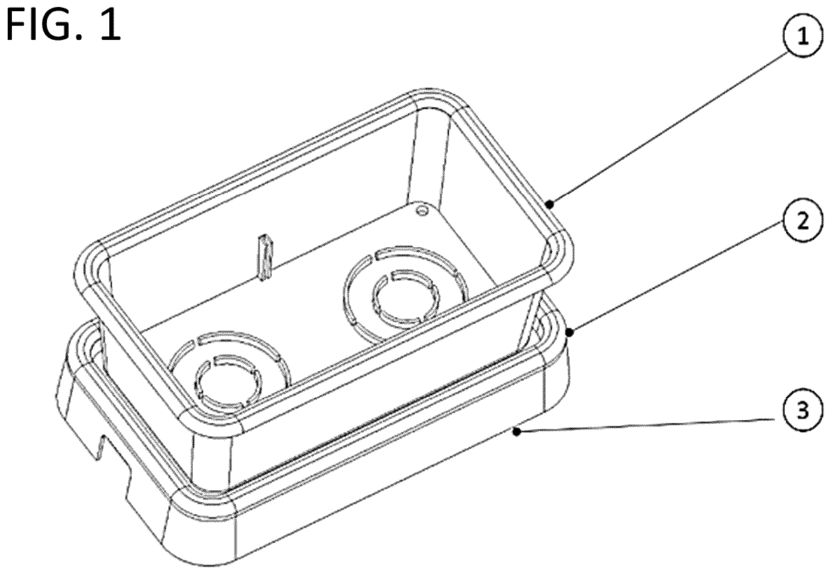

In the case of FIG. 1, the street furniture 1 is a pot.

Separated by the adapter 2, the street furniture 1 is positioned on the container 3.

It is the object of the adapter 2 to conceal the bait from human view.

The adapter 2 links the street furniture 1 to the container 3 (FIG. 1).

The adapter 2 adapts to different shapes and geometries of the street furniture 1. The adapter 2 adapts to different shapes and geometries of the container 3.

The adapter 2 holds the container 3 in place and serves as a bottom bait feeder.

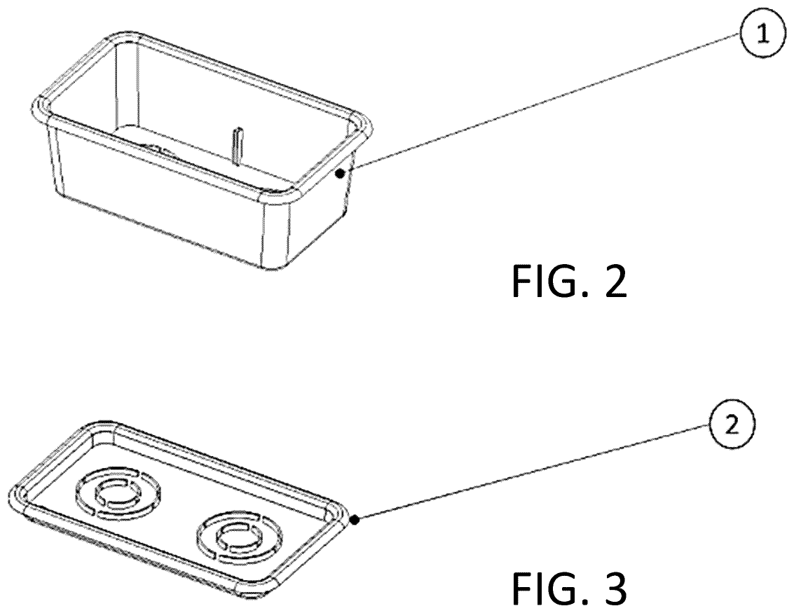

FIG. 2 shows a perspective view of the street furniture 1. In FIG. 2, the street furniture 1 is a pot. The pot has a circumferential sidewall that is closed off at the bottom by a base.

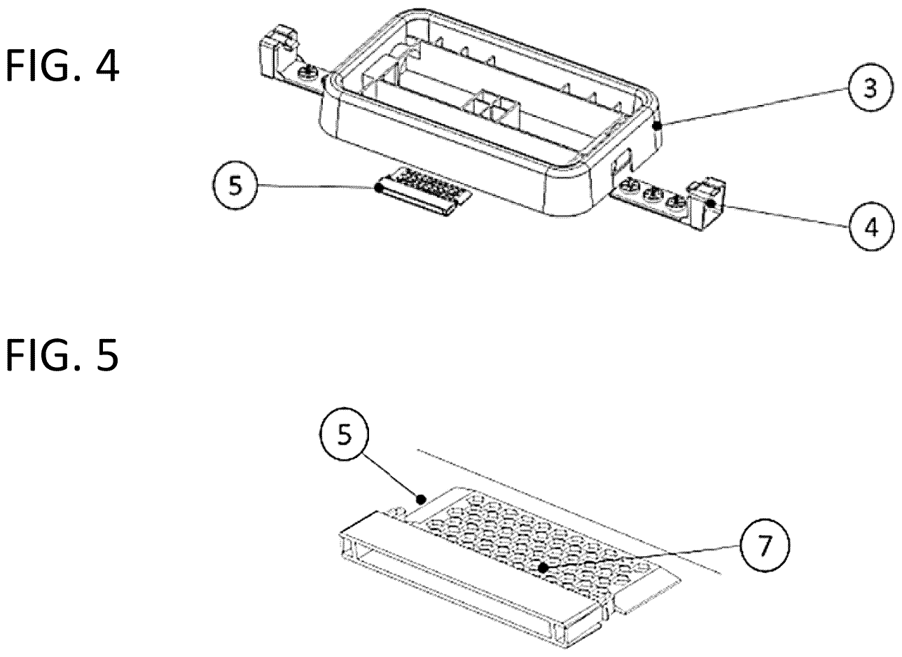

FIG. 3 shows the perspective view of the adapter 2. When assembled, adapter 2 (FIG. 3) connects the street furniture 1 (FIG. 2) to the container 3 (FIG. 4).

The container 3 holding the bait (FIG. 4) is stacked and/or rigidly fixed under the street furniture 1 (FIG. 1).

Every container 3 holding bait is equipped with at least one removable bait holder 4 for bigger pest and/or at least one removable bait holder 5 for smaller pest.

In FIGS. 4 to 8 the bait holders 4 and 5 are shown to be movable sideways in relation to the container 3. To remove the bait holders 4 and 5 a self-retaining and/or re-setting clip 10 is arranged.

Both the bait holder 4 and the bait holder 5 can be extracted (FIG. 4).

FIG. 4 shows at least one second type of bait holder 5. The bait holder 5 serves to kill smaller pests.

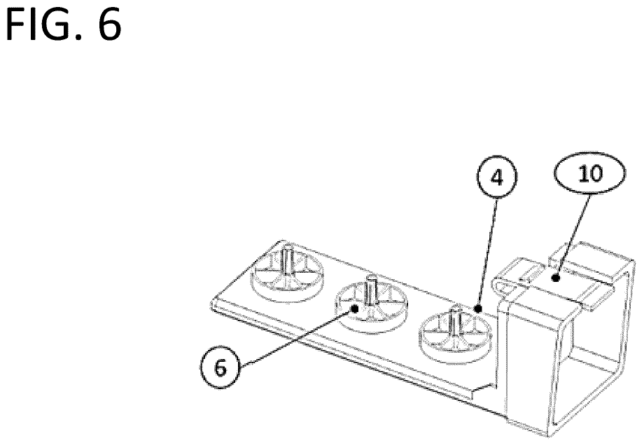

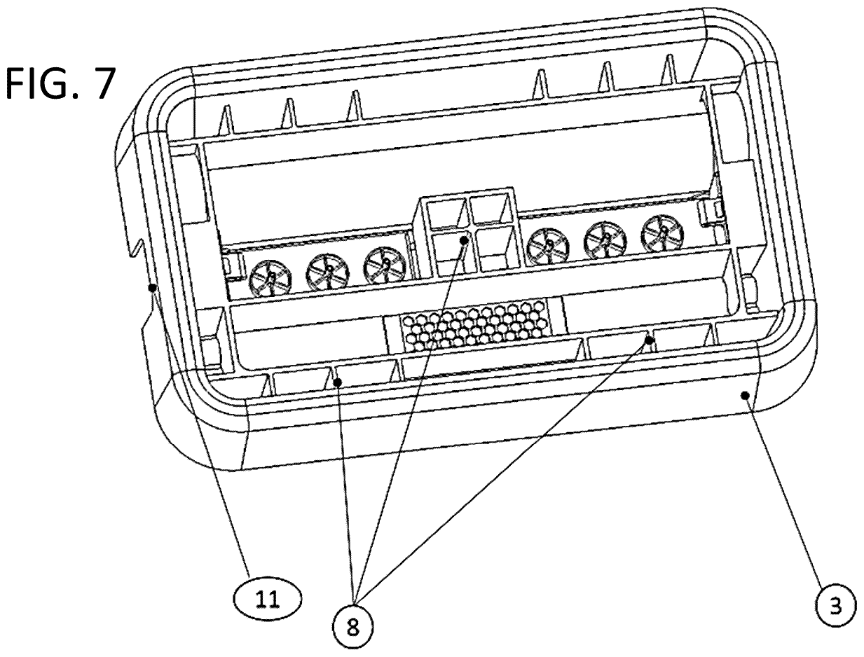

The bait holder 4 (FIG. 6) is designed to hold solid and/or semi-solid baits for larger pests.

In FIG. 6, each bait holder 4 has at least one or more features 6, the bait being attached to the features 6.

FIG. 5 and FIG. 7 show that features 6 provide at least one or more raised surfaces. On the raised surfaces the bait is protected from water and/or protected from fluids.

The toxic material to attract smaller pests (ants; roaches) can be designed in the form of a honeycomb structure 7 (FIG. 5).

The honeycomb structure 7 is designed to hold small amounts of a pasty bait by capillary action.

The bait holders 4 and 5 can be extracted for cleaning and/or for refilling purposes. Each bait holder 4 and 5 can be replaced individually.

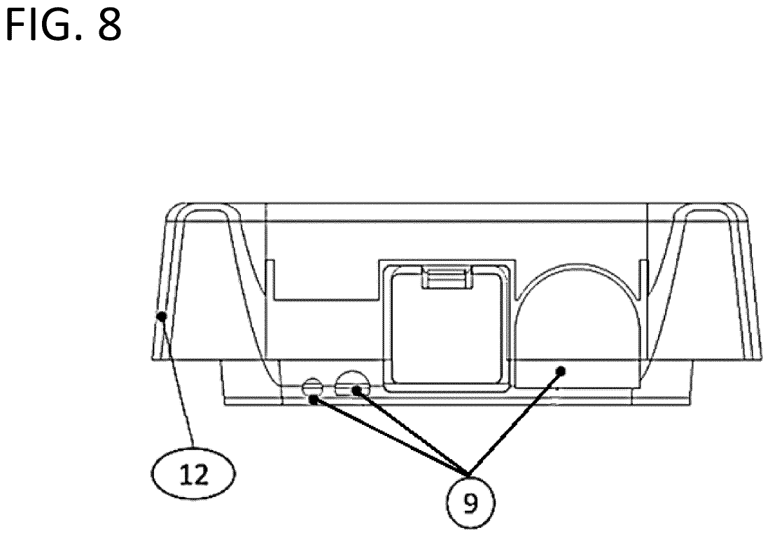

FIG. 8 shows a bait holder 4, 5 having geometric features 12.

The geometric features 12 of FIG. 8 hide three openings 9.

The openings 9 are designed to receive different sized pests.

The openings 9 channel the pests to the correct bait. Opening 11 gives access to the bait holders 4, 5 without revealing the pest opening to normal users.

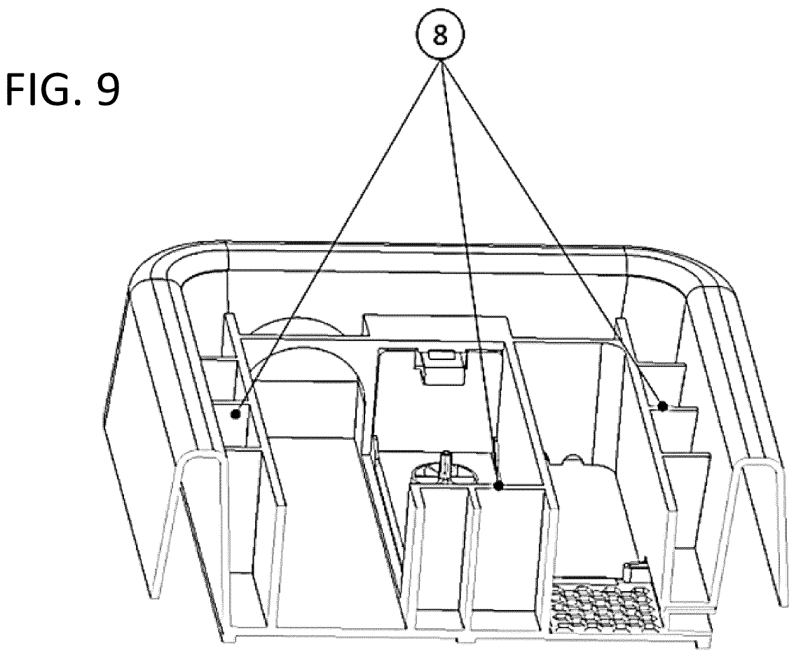

The furniture 1 of FIG. 9 can be heavier than the container 3.

The device comprising the container 3 is placed underneath a furniture.

The adapter 2 covers the container 3 against fluid ingress. The adapter 2 connects the container 3 and the street furniture 1.

To bear the weight of the container 3, on the rim and/or on the middle of the street furniture 1 a reinforcing structure 8 can be arranged.

The rim and/or the middle of the reinforcing structure 8 of the furniture 1 allows the device with its container 3 to be placed underneath different types of street furniture 1.

To fit underneath any type of furniture 1, the adapter 2 can be changed and/or modified as well.

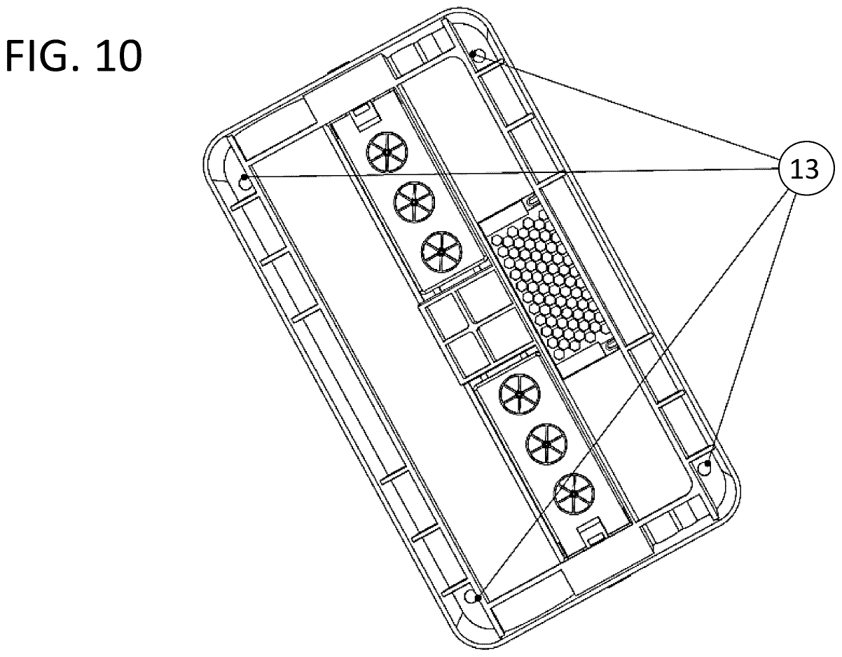

FIG. 10 shows a top view of the container (3). In each edge, the container (3) has one drain hole and/or drain channel (13), which directs any leaking fluids away from the bait.

### LIST OF REFERENCE NUMBERS

1 Street furniture
2 Adapter
3 Container for receiving bait (toxic material)
4 Holder for bigger pest
5 Holder for smaller pest
6 Feature
7 Honeycomb structure
8 Reinforcing structure
9 Multiple opening for receiving pest
10 Re-setting clip
11 Opening to bait holder
12 Geometric feature
13 drain hole and/or drain channel

1. A device for dispensing a bait, the bait comprising toxic material configured for killing a pest in an area of a street furniture wherein the device comprises a container for receiving the bait, and
an adapter linking the container to the street furniture.

2. The device according to claim 1, wherein at least one of the container and/or the adapter is adapted to connect to the street furniture

3. The device according to claim 1, wherein the container comprises at least one opening for receiving the pest.

4. The device according to claim 1, wherein the container comprises at least one opening for receiving a holder for the bait.

5. The device according to claim 4, wherein the holder carrying bait is removeable relative to the container of the device.

6. The device according to claim 4, wherein the holder is adapted for carrying the bait.

7. The device according to claim 1, wherein the container has a reinforcing structure adapted to support a weight of the street furniture.

8. The device according to claim 1, wherein the container has at least one drain to direct any leaking fluids away from the bait.

9. The device according to claim 6 wherein the holder has a honeycomb structure adapted for carrying the bait.
